(19) United States
(12) Patent Application Publication
(10) Pub. No.: US 2009/0016738 A1
(43) Pub. Date: Jan. 15, 2009

(54) COMPACT ALL-OPTICAL CLOCK RECOVERY DEVICE

(75) Inventors: Tuomo Von Lerber, Helsinki (FI); Seppo Honkanen, Helsinki (FI); Franko Kueppers, Tucson, AZ (US)

Correspondence Address: VENABLE LLP, P.O. BOX 34385, WASHINGTON, DC, 20043-9998, US

(73) Assignee: Luxdyne Oy, Helsinki (FI)

(21) Appl. No.: 12/280,663

(22) PCT Filed: Feb. 24, 2006
(86) PCT No.: PCT/FI06/50080

§ 371 Date: Aug. 25, 2008

(51) Int. Cl. H04B 10/02

(52) U.S. Cl. 398/155

(57) ABSTRACT

A clock recovery device adapted to recover at least one clock signal from an optical input signal. The input signal includes at least one data signal. The clock recovery device-includes a first waveguide, a first optical resonator coupled to the first waveguide, a second optical resonator coupled to the first waveguide, and a combiner to combine signals provided by the first optical resonator and the second optical resonator in order to provide an output signal. A passband of the first optical resonator is matched with a first spectral peak of the input signal, and a passband of the second optical resonator is matched with a second spectral peak of the input signal such that the spectral separation between the first and the second peaks is equal to a clock frequency associated with a first data signal. The optical resonators store optical energy and provide an output also when the data signal is zero. Thus, the output signal includes a first recovered clock signal which exhibits continuous beat at the first clock frequency. The optical resonators are coupled to the same waveguide by evanescent coupling. A high coupling efficiency may be achieved and the use of further optical splitters may be avoided.

### BACKGROUND OF THE INVENTION

Optical clock recovery is needed e.g. to synchronize receivers with transmitters in optical communication systems, especially in all-optical systems having modulation frequencies in the order of 10 GHz or higher.

When an optical resonator is matched with a spectral peak of a signal, it is capable of storing optical energy associated with the frequency of said spectral peak. Consequently, the optical resonator may provide a continuous optical output also during periods when the input signal is at the zero level.

An optical resonator may be matched with the carrier frequency and the sideband frequency of an optical data signal such that the spectral separation between said frequencies is equal to the clock frequency associated with the data signal. In that case the output of the optical resonator exhibits a continuous beat at the clock frequency, i.e. the clock signal may be recovered.

The article “Optical Tank Circuits Used for All-Optical Timing Recovery”, by M. Jinno and T. Matsumoto, IEEE Journal of Quantum Electronics Vol. 28, No. 4 Apr. 1992, pp. 895-900, discloses a method for optical clock recovery. An optical clock signal synchronized to an incoming data stream is generated by extracting line spectral components in the incoming data stream using an optical resonator whose free spectral range is equal to the incoming data bit rate.

When an optical resonator is applied to the simultaneous processing of several spectrally separate signals, the spectral position of the signals is determined by the spectral separation between the resonance frequencies of the resonator.

Two or more optical resonators may be used in order to allow more freedom to select the spectral positions of the signals. Optical splitters and combiners may be needed to distribute the signals to the resonators, which adds complexity to the systems and reduces their stability.

### SUMMARY OF THE INVENTION

The object of the present invention is to provide an all-optical clock recovery device. The object of the present invention is also to provide a method for recovering one or more clock signals. The object of the present invention is also to provide an optical communications system comprising said clock recovery device.

According to a first aspect of the invention, there is a method of recovering at least one clock signal from an optical input signal, said input signal comprising one or more spectrally separate data signals, said method comprising:

coupling said input signal to a first waveguide,

matching a passband of a first optical resonator with a first spectral peak of said input signal,

matching a passband of a second optical resonator with a second spectral peak of said input signal, the spectral separation between said first and said second spectral peaks being equal to a clock frequency associated with a first data signal,

coupling a first portion of said input signal from said first waveguide to said first optical resonator,

coupling at second portion of said input signal from said first waveguide to said second optical resonator,

coupling a first processed signal out of said first optical resonator,

coupling a second processed signal out of said second optical resonator, and

combining said first and said second processed signal in order to form an output signal, said output signal comprising a first recovered clock signal associated with said first data signal.

According to a second aspect of the invention, there is a method of recovering at least two clock signals from an optical input signal, said input signal comprising one or more spectrally separate data signals, said method comprising:

coupling said input signal to a first waveguide,

matching a passband of a first optical resonator with a first spectral peak of said input signal,

matching a passband of said first optical resonator with a second spectral peak of said input signal,

matching a passband of a second optical resonator with a third spectral peak of said input signal,

matching a passband of said second optical resonator with a fourth spectral peak of said input signal,

the spectral separation between said first and said second spectral peaks being equal to a clock frequency associated with a first data signal, and the spectral separation between said third and said fourth spectral peaks being equal to a clock frequency associated with a first data signal,

coupling a first portion of said input signal from said first waveguide to said first optical resonator,

coupling a second portion of said input signal from said first waveguide to said second optical resonator,

coupling a first recovered clock signal out of said first optical resonator, and

coupling a first recovered clock signal out of said second optical resonator.

According to a third aspect of the invention, there is a clock recovery device for recovering at least one clock signal from an optical input signal, said input signal comprising one or more spectrally separate data signals, said device comprising:

a first waveguide,

a first optical resonator coupled to said first waveguide, a passband of said first optical resonator being matched with a first spectral peak of said input signal,

a second optical resonator coupled to said first waveguide optically in parallel with said first optical resonator, a passband of said second optical resonator being matched with a second spectral peak of said input signal such that the spectral separation between said first and said second peaks is equal to a clock frequency associated with a first data signal, and

a second waveguide (6) to combine signals provided by said first optical resonator and said second optical resonator, said second waveguide being adapted to provide an output signal comprising a recovered clock signal associated with the first data signal.

According to a fourth aspect of the invention, there is an optical system comprising:

transmitting means adapted to send an optical input signal, said input signal comprising one or more spectrally separate data signals,

a transmission path to transmit said input signal,

receiving means to receive said input signal, and

a clock recovery device to recover at least one clock signal from said optical input signal,

said clock recovery device comprising:

a first waveguide,

a first optical resonator coupled to said first waveguide, a passband of said first optical resonator being matched with a first spectral peak of said input signal,

a second optical resonator coupled to said first waveguide optically in parallel with said first optical resonator, a passband of said second optical resonator being matched with a second spectral peak of said input signal such that the spectral separation between said first and said second spectral peak is equal to a clock frequency associated with a first data signal, and

a second waveguide to combine signals provided by said first optical resonator and said second optical resonator, said second waveguide being adapted to provide an output signal comprising a recovered clock signal associated with said first data signal.

According to a fifth aspect of the invention, there is a method of recovering at least two clock signals from an optical input signal, said input signal comprising two or more spectrally separate data signals, said method comprising:

coupling said input signal to a first waveguide,

matching a passband of a first optical resonator with a first spectral peak of said input signal,

matching a passband of a second optical resonator with a second spectral peak of said input signal,

coupling a first portion of said input signal from said first waveguide to said first optical resonator,

coupling a second portion of said input signal from said first waveguide to said second optical resonator,

coupling a first processed signal out of said first optical resonator,

coupling a second processed signal out of said second optical resonator,

combining said first processed signal with auxiliary light in order to form a first recovered clock signal associated with a first data signal, and

combining said second processed signal with auxiliary light in order to form a second recovered clock signal associated with a second data signal, said auxiliary light having a third and a fourth spectral peak such that the spectral separation between said first peak and said third peak is equal to a first clock frequency associated with said first data signal, and such that the spectral separation between said second peak and said fourth peak is equal to a second clock frequency associated with said second data signal.

According to the present invention, the clock recovery device comprises at least two optical resonators coupled optically in parallel to the same waveguide. Thus, the distribution of an optical input signal to the resonators is very simple, and the coupling efficiency from a waveguide to the resonators may be very high. Yet, the spectral stability of the clock recovery device may be improved.

Thanks to the use of the common waveguide for distributing the optical input signal, also further optical resonators, e.g. a third resonator may be easily added to the clock recovery device. The use of two, three or more optical resonators provides considerable freedom to select the spectral positions of the transmitted data signals and/or their clock frequencies.

The embodiments of the invention and their benefits will become more apparent to a person skilled in the art through the description and examples given herein below, and also through the appended claims.

### BRIEF DESCRIPTION OF THE FIGURES

In the following examples, the embodiments of the invention will be described in more detail with reference to the appended drawings, in which

FIG. 1 shows a block diagram of an optical communication system,

FIG. 2 shows, by way of example, a return-to-zero (RZ) modulated data signal and a corresponding clock signal,

FIG. 3a shows schematically a spectral decomposition of an optical data signal,

FIG. 3b shows schematically a spectral decomposition of a carrier-suppressed optical data signal,

FIG. 4 shows schematically an optical ring resonator,

FIG. 5a shows schematically a clock recovery device comprising two optical ring resonators coupled optically in parallel,

FIG. 5b shows schematically a clock recovery device comprising a waveguide which consists of several successive portions,

FIG. 6 shows schematically matching of optical resonators with the spectral peaks of an optical input signal,

FIG. 7 shows schematically the temporal behavior of a reference component, a sideband component, and a beat signal corresponding to the data signal of FIG. 2,

FIG. 8 shows a block diagram of an optical communication system adapted to transmit optical data signals at a plurality of optical channels,

FIG. 9 shows schematically matching of optical resonators with spectral peaks of several data signals,

FIG. 10 shows schematically a clock recovery device comprising five optical ring resonators coupled optically in parallel.

FIG. 11 shows schematically matching of optical resonators with spectral peaks of several data signals, said data signals having different clock frequencies but the same spectral separation between reference frequencies,

FIG. 12 shows schematically a spectral demultiplexer coupled to a clock recovery device,

FIG. 13 shows schematically a clock recovery device comprising several output waveguides to provide several spatially separate output signals,

FIG. 14 shows schematically a clock recovery device comprising optical ring resonators coupled in series,

FIG. 15 shows schematically a clock recovery device comprising a first group of resonators coupled in series, a second group of resonators coupled in series, and a third group consisting of a single resonator,

FIG. 16 shows schematically a signal pre-processing unit coupled to a clock recovery device,

FIG. 17 shows schematically an output stabilizing unit coupled to a clock recovery device,

FIG. 18 shows schematically spectral stabilizing of a transmitting unit,

FIG. 19 shows schematically spectral matching of optical resonators and auxiliary light with spectral peaks of spectrally separate optical data signals,

FIG. 20 shows schematically combining of the output of a clock signal recovery device with auxiliary light using a combiner,

FIG. 21 shows schematically introducing of auxiliary light to the end of the second waveguide of a clock signal recovery device,

FIG. 22 shows schematically a clock recovery device implemented by using photonic structures,

FIG. 23 shows the clock recovery device according to FIG. 23 such that waveguiding and optically resonating structures are outlined by dashed lines,

FIG. 24 shows schematically a clock recovery device comprising fiber optic Fabry-Perot resonators, and

FIG. 25 shows schematically a clock recovery device comprising fiber optic Fabry-Perot resonators, said device having two spatially separate outputs.

### DETAILED DESCRIPTION

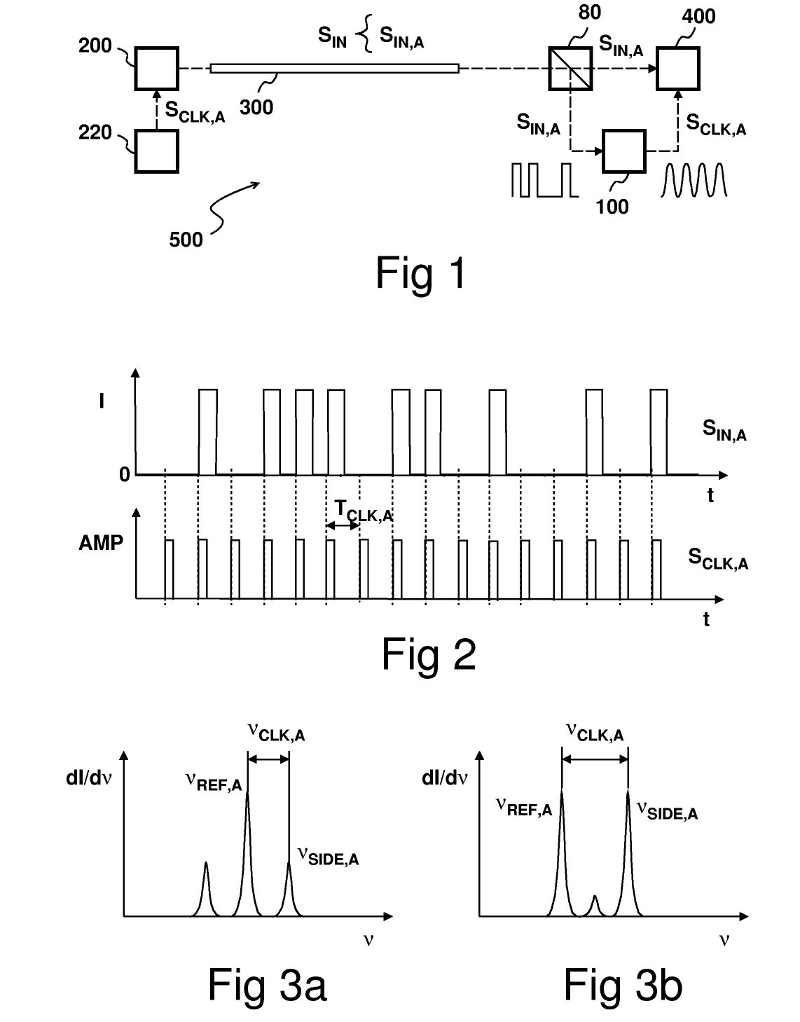

Referring to FIG. 1, an optical communication system 500 comprises an optical transmitting unit 200, an optical transmission path 300, and an optical receiving unit 400. An optical signal S_{IN} is sent by the transmitting unit 200. The optical signal S_{IN} is transmitted through the transmission path 300, which may be e.g. an optical fiber. The optical signal S_{IN} comprises at least one modulated data signal S_{IN,A}. The modulation of the signal S_{IN,A} is controlled by a clock signal S_{CLK,A} provided by a clock 220. The receiving unit 400 is synchronized with the data signal S_{IN,A} by using a clock signal S_{CLK,A} recovered by a clock recovery device 100. A splitter 80 may be used to distribute the signal S_{IN}.

Referring to FIG. 2, the data signal S_{IN,A} may consist of a sequence of pulses modulated e.g. according to the return-to-zero format (RZ). The timing of the pulses is controlled by the clock signal S_{CLK,A}, which is shown by the lower curve of FIG. 2. The time period between two consecutive clock pulses is T_{CLK,A}, and the clock frequency ν_{CLK,A} is equal to 1/T_{CLK,A}, respectively The spectral decomposition of the modulated data signal S_{IN,A} may exhibit a spectral peak at a reference frequency ν_{REF,A} and a spectral peak at a sideband frequency ν_{SIDE,A} such that the spectral separation between the sideband frequency ν_{SIDE,A} and the reference frequency ν_{REF,A} is equal to the clock frequency ν_{CLK,A}. Referring to FIG. 3a, the reference frequency ν_{REF,A} may be the carrier frequency of the modulated signal S_{IN,A}.

Referring to FIG. 3b, the reference frequency ν_{REF,A} may also be a second sideband frequency of a carrier-suppressed modulated signal S_{IN,A}.

The spectral decomposition of the signal may exhibit several spectral peaks, from which a reference peak and a sideband peak may be selected such that their spectral separation is equal to the clock frequency ν_{CLK,A}.

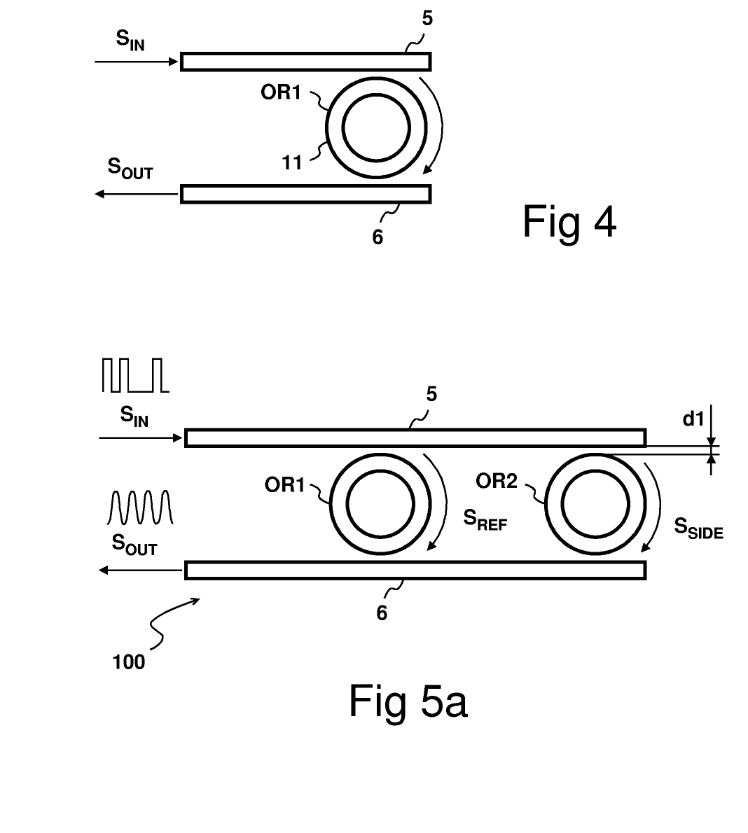

An optical resonator is a device which is capable of storing optical energy in a frequency-selective way. Micro ring resonators are a type of optical resonators. Referring to FIG. 4, a micro ring resonator OR1 consists of a closed optical loop 11, said loop forming a closed optical path for traveling light waves. The light wave interferes with itself while traveling in the loop. The interference may be constructive or destructive. Constructive interference is associated with high energy density in the loop and increased transmittance from one side of the loop to the other side.

Waveguides 5, 6 may be used to couple light in and out of the ring resonator OR1. The combination of the waveguides 5, 6 and the ring resonator OR1 acts as a band pass filter having a plurality of pass bands which coincide with the optical resonance frequencies of the ring resonator OR1.

Adjacent resonance frequencies of the ring resonator OR1 are separated by a separation range Δν_{SR} given by:

$$Δ {v}_{SR} = \frac{c}{nL} , \qquad ( 1 )$$

where c is the speed of light in vacuum, n is the index of refraction of the loop medium, and L is the length of the closed optical loop.

The separation range Δν_{SR} may be substantially constant over a predetermined range of optical frequencies. In order to implement a constant separation range, the ring resonator OR1 may be non-dispersive. On the other hand, the ring resonator OR1 may also be dispersive to provide a wavelength-dependent separation range.

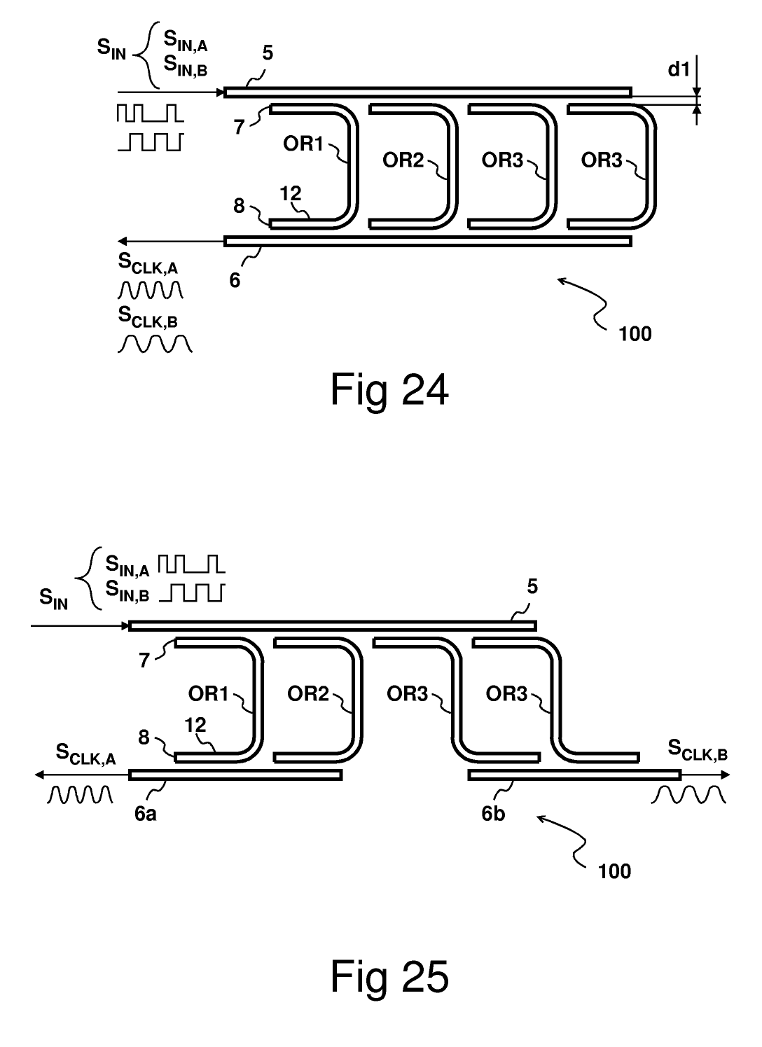

Fabry-Perot-type resonators are optical resonators which comprise a cavity defined by at least two reflectors (See FIGS. 24, 25). Also the Fabry-Perot resonators have a plurality of resonance frequencies which are spectrally separated by a separation range Δν_{SR}.

An optical resonator OR1 has the capability to store optical energy associated with a light wave traveling in the closed loop. Thus, the optical resonator OR1 can sustain its state for some time regardless of perturbations of the optical input signal S_{IN}. However, the output provided by the optical resonator starts to decay after the input is switched to the zero level. The decay may be described by a time constant τ, which is the time period during which the intensity of the signal decreases by 63%.

In case of a return-to-zero (RZ) modulated signal, the time constant τ of the optical resonator OR1 is advantageously selected to be greater than or equal to the average time period during which the data signal S_{IN,A} remains at zero level.

In general, for example in the case of non-return-to-zero (NRZ) signals, the time constant τ is advantageously selected to be greater than or equal to the average time period during which the data signal S_{IN,A} does not change its state.

The form of the closed optical path of the ring resonator OR1 may be e.g. circular, oval, triangular or rectangular. The ring resonator may consist of a fiber optic loop or a waveguide loop. The form of the optical path of the ring resonator OR1 may be oval such as disclosed in U.S. Pat. No. 6,885,794. The ring resonator OR1 may be implemented by polymer technology such as disclosed e.g. in US Patent Publication 2003/0217804. The ring resonator OR1 may be implemented by nanocomposite technology such as disclosed in U.S. Pat. No. 6,876,796.

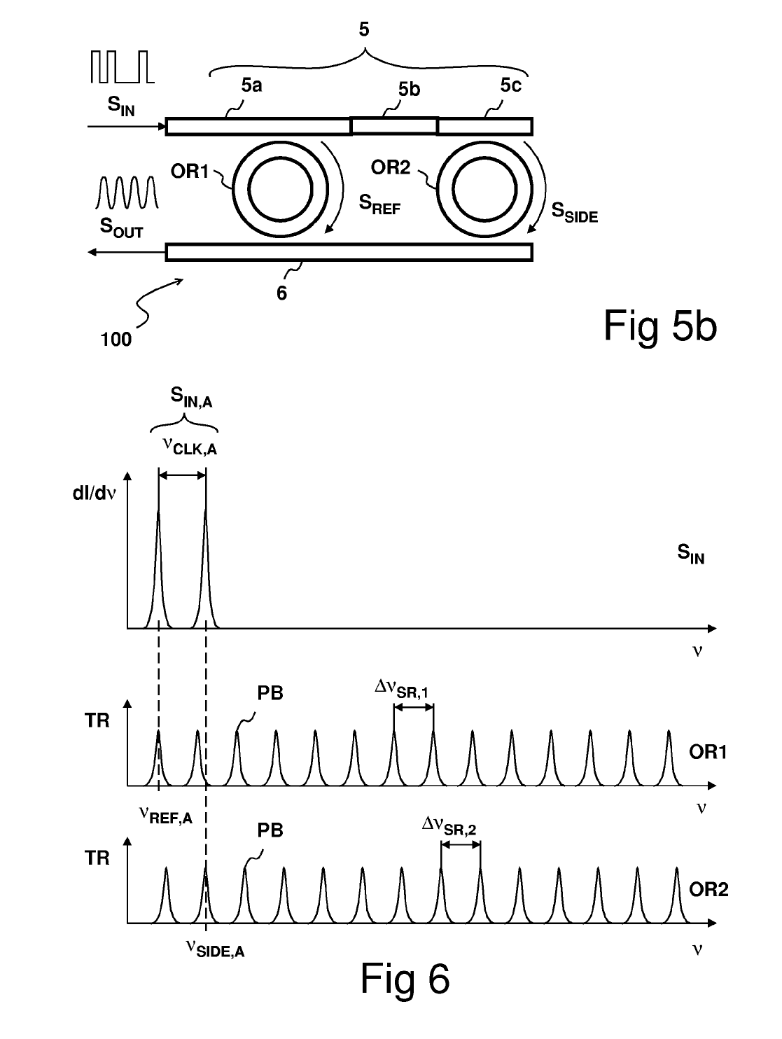

FIG. 5a shows an embodiment of the clock recovery device 100 comprising two ring resonators OR1, OR2. The input signal S_{IN} is distributed to the ring resonators OR1, OR2 by using a first common waveguide 5. A first spectral component of the S_{IN} is coupled from the common waveguide 5 to the first ring resonator OR1, and a second spectral component of the S_{IN} is coupled from the common waveguide 5 to the second ring resonator OR2. The coupling may be implemented e.g. by evanescent coupling. The first spectral component is at the reference frequency ν_{REF,A} and the second spectral component is at the sideband frequency ν_{SIDE,A} of the input signal S_{IN} (see FIGS. 3a and 3b). The first spectral component is processed by the first ring resonator OR1 to form a reference signal S_{REF}. The second spectral component is processed by the second ring resonator OR2 to form a sideband signal S_{SIDE}. The reference signal S_{REF} and the sideband signal S_{SIDE} are combined when they are coupled from the ring resonators OR1, OR2 to a second common waveguide 6. The output signal S_{OUT} is the superposition of the reference signal S_{REF} and the sideband signal S_{SIDE}.

The ring resonators OR1, OR2 are coupled optically in parallel between the waveguides 5, 6; i.e. the signal component S_{REF} which is transmitted through the first ring resonator OR1 is not coupled to the second ring resonator OR2. The signal component S_{SIDE} which is transmitted through the second ring resonator OR2 is not coupled to the first ring resonator OR1, respectively.

The first ring resonator OR1 and the second ring resonator OR2 are coupled to the same waveguide 5, i.e. to a common waveguide.

The signal S_{IN} may be coupled directly from the side of the first waveguide 5 to the ring resonators OR1, OR2 by evanescent coupling. The distance d1 between the side of the waveguide 5 and the cavity, i.e. the loop of the ring resonator may be e.g. in the range of 0.05 to 1 times the wavelength of the coupled signal. The side of the waveguide 5 may be defined e.g. by a boundary which encloses 80% of the optical power transmitted at said wavelength. For step-index waveguides, the side may be defined by the boundary of the core.

Referring to FIG. 5b, the common waveguide 5 may also consist of several successive portions 5a, 5b, 5c. A part of the input signal S_{IN} is coupled from the first portion 5a to the first ring resonator OR1. The remaining part of the input signal S_{IN} is transmitted in one direction through said first portion 5a to the further portions 5b, 5c, from which the remaining part of the input signal S_{IN} is coupled to further ring resonators, e.g. to the second ring resonator OR2.

The input signal S_{IN} comprises at least one data signal S_{IN,A}. Referring to FIG. 6, one of the passbands PB of the first optical resonator OR1 is matched with a first spectral peak ν_{REF,A} of the a data signal S_{IN,A}, and one of the passbands PB of the second optical resonator OR2 is matched with a second spectral peak ν_{SIDE,A} of the data signal S_{IN,A}. The spectral peaks are selected from the spectral decomposition of the input signal S_{IN} such that their spectral separation is equal to the clock frequency ν_{CLK,A} associated with the data signal S_{IN,A}. The spectral decomposition may be obtained e.g. by Fourier analysis of the input signal S_{IN}.

The first optical resonator OR1 has a separation range Δν_{SR,1} between adjacent passbands PB. The second optical resonator OR2 has a separation range Δν_{SR,2} between the adjacent passbands PB.

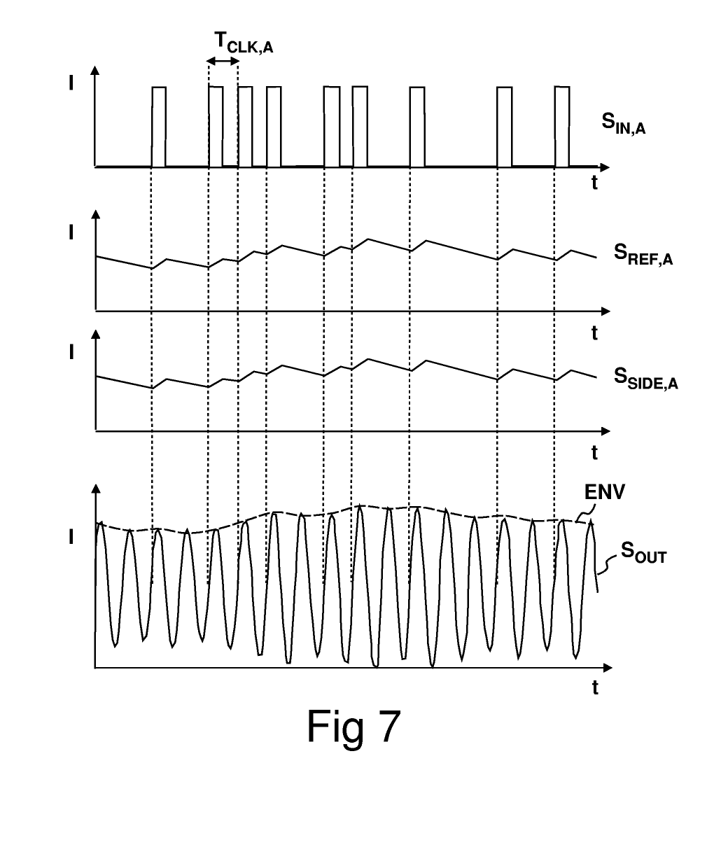

The first optical resonator OR1 provides a reference component S_{REF,A} and the second optical resonator OR2 provides a sideband component S_{SIDE,A}, when the data signal S_{IN,A} is coupled to the matched resonators OR1, OR2. FIG. 7 shows the temporal behavior of the reference component S_{REF,A} (FIG. 5) and the sideband component S_{SIDE,A} corresponding to the return-to-zero-modulated (RZ) data signal S_{IN,A} of FIG. 2.

The uppermost curve shows the data signal S_{IN,A}. The second curve from the top shows the temporal behavior of the reference component S_{REF,A}. The third curve from the top shows the temporal behavior of the sideband component S_{SIDE,A}. The intensity of the reference component S_{REF,A} decreases when no optical energy is introduced into the optical resonator OR1. In other words, the optical resonator OR1 is discharged. The intensity of the reference component S_{REF,A} increases when optical energy is introduced to the optical resonator OR1. In other words, the optical resonator OR1 is charged. Also the intensity of the sideband component S_{SIDE,A} increases and decreases depending on whether optical energy is coupled to the second optical resonator OR2 or not.

The lowermost curve of FIG. 7 shows the temporal behavior of the output signal S_{OUT}, which is the superposition of the reference and sideband components S_{REF,A}, S_{SIDE,A}. The output signal S_{OUT} exhibits a beat at the clock frequency ν_{CLK,A} corresponding to the modulation of the input signal S_{IN}. The envelope ENV of the output signal S_{OUT} fluctuates according to the fluctuating components S_{REF,A}, S_{SIDE,A}. It is emphasized that although the envelope ENV fluctuates, the amplitude of the beat of the output signal approaches zero only when the data signal S_{IN,A} is at a zero level for a long time. Thus, the output signal S_{OUT} comprises a recovered continuous clock signal.

The clock recovery device 100 may further comprise means to stabilize the amplitude and/or waveform of the recovered clock signal.

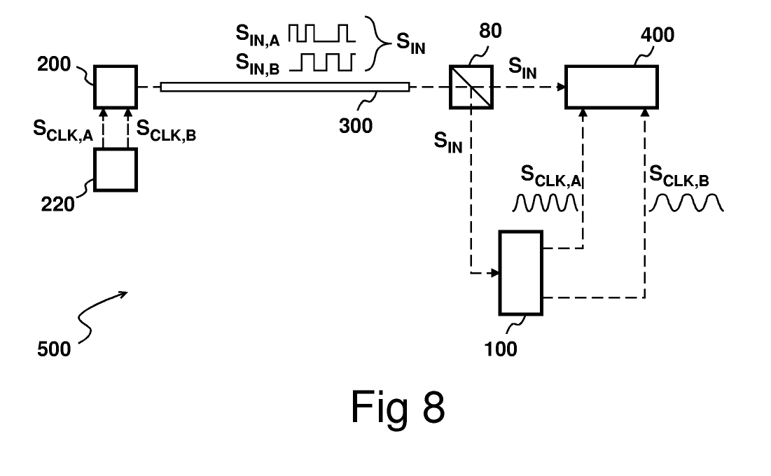

Referring to FIG. 8, the optical input signal S_{IN} may comprise several optical data signals S_{IN,A}, S_{IN,B}, which are sent through the same transmission path 300 but which are spectrally separate from each other, i.e. sent at different optical channels. The data signals S_{IN,A}, S_{IN,B} may have different clock frequencies ν_{CLK,A}, ν_{CLK,B}. The clock frequencies of the different data signals may also be equal but in different phases. The receiving unit 400 is synchronized with the incoming data signals S_{IN,A}, S_{IN,B} by using the recovered clock signals S_{CLK,A} and S_{CLK,B}.

The spectral positions of optical channels in fiber optic networks have been standardized e.g. by the International Telecommunication Union. The separation between optical channels, i.e. the separation between the reference frequencies ν_{REF,A}, ν_{REF,B} may be e.g. 100 GHz in the frequency domain.

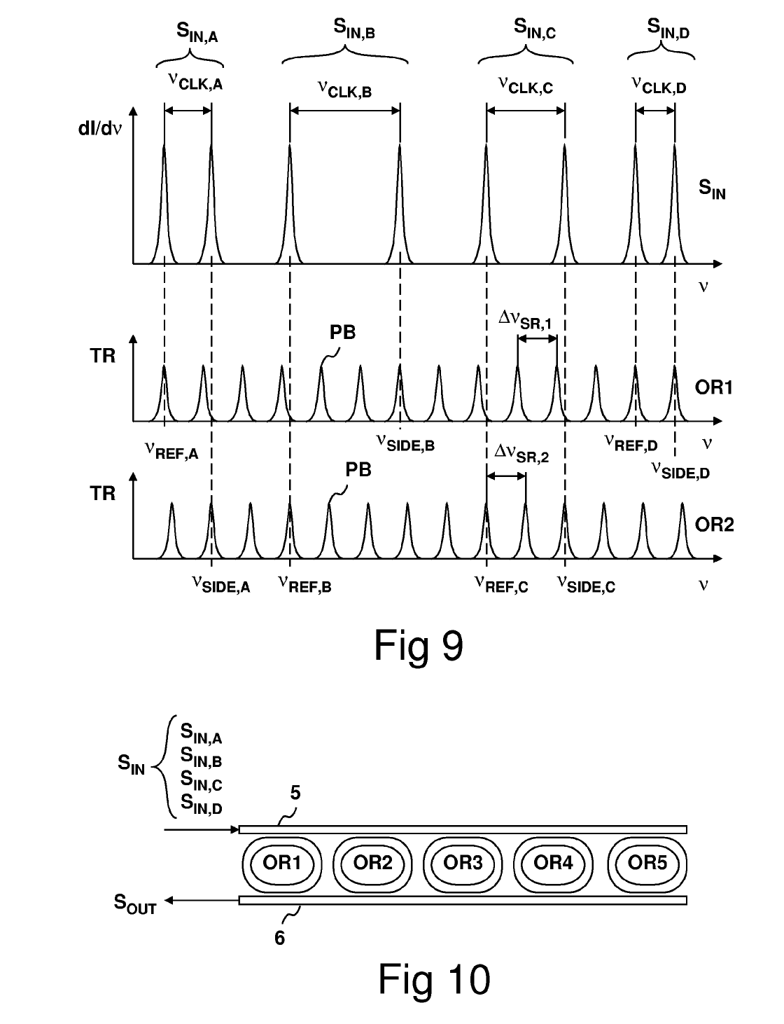

Referring to FIG. 9, a plurality of spectral peaks may be simultaneously matched with the pass bands PB of the optical resonators OR1, OR2. Several clock signals may be recovered simultaneously by the clock recovery device 100.

The first data signal S_{IN,A} consists of spectral peaks at ν_{REF,A} and ν_{SIDE,A}, and it has a clock frequency ν_{CLK,A}. The second data signal S_{IN,B} has spectral peaks at ν_{REF,B} and ν_{SIDE,B}, and a clock frequency ν_{CLK,B}. The third data signal S_{IN,C} has spectral peaks at ν_{REF,C} and ν_{SIDE,C}, and a clock frequency ν_{CLK,C}. The fourth data signal S_{IN,D} has spectral peaks at ν_{REF,D} and ν_{SIDE,D}, and a clock frequency ν_{CLK,D}. The input signal SIN may comprise even further data signals.

Now, for example, the peaks ν_{REF,A}, ν_{SIDE,B}, ν_{REF,D} and ν_{SIDE,D} may be matched with the first optical resonator OR1, and the peaks ν_{SIDE,A}, ν_{REF,B}, ν_{REF,C} and ν_{SIDE,C} may be matched with the second optical resonator OR2. The first optical resonator OR1 has a separation range Δν_{SR,1} between adjacent passbands PB. The second optical resonator OR2 has a separation range Δν_{SR,2} between adjacent passbands PB. The first optical resonator OR1 and the second optical resonator OR2 may have equal or different separation ranges Δν_{SR,1} and Δν_{SR,2}.

The optical resonators OR1, OR2 store optical energy at the matched frequencies. Thus, the clock recovery device 100 may simultaneously provide a plurality of continuous beat signals which correspond to the clock signals of the several data channels.

In general, one pass band PB of the optical resonators is set to match with a reference frequency, and one pass band PB of the optical resonators is set to match with a sideband frequency for each optical data signal from which the clock frequency is to be recovered.

The clock recovery device 100 may comprise two or more optical resonators OR1, OR2 coupled optically in parallel. The use of two or more optical resonators OR1, OR2 allows substantial freedom to select the spectral positions of the optical data signals, and the clock frequencies of those data signals. The number of the recovered clock frequencies may be significantly higher than the number of the optical resonators OR1, OR2.

The pass bands PB of the second optical resonator OR2 may be simultaneously adapted to correspond to a set of frequencies ν_{q} given by:

ν_{q}=ν_{REF,A}+qΔν_{SR,2}+ν_{CLK,A}, (2)

where q is an integer ( . . . −2, −1, 0, 1, 2, 3, . . . ), ν_{REF,A} is reference frequency of a first data signal, Δν_{SR,2} is the separation between the pass bands PB of the second optical resonator OR2 and ν_{CLK,A} is the clock frequency of the first data signal.

Instead of the equation (2), the pass bands PB of the second optical resonator OR2 may also be simultaneously adapted to correspond to a set of frequencies ν_{q} given by:

ν_{q}=ν_{REF,A}+qΔν_{SR,2}−ν_{CLK,A}, (3)

For example, the separation between the reference frequencies ν_{REF,A, ν}_{REF,B} of adjacent data signals may be 100 GHz, the separation range Δν_{SR,2} may be 50 GHz and the clock frequency ν_{CLK,A} may be 10 GHz. In that case, according to the equation (2), the second optical resonator OR2 may be adapted to simultaneously process frequencies ν_{0,A} −140 GHz ν_{0,A}−90 GHz, ν_{0,A}−40 GHz, ν_{0,A} +10 GHz, ν_{0,A} +60 GHz, ν_{0,A} +110 GHz, ν_{0,A}+160 GHz, ν_{0,A}+210 GHz . . . . Consequently, clock frequencies associated with several data signals may be recovered simultaneously, providing that each reference frequency and each sideband frequency of said data signals matches with a passband PB of the optical resonators OR1, OR2. An example of a possible combination of reference frequencies and clock frequencies is presented in Table 1.

TABLE 1
An example of a possible combination of reference
frequencies, clock frequencies and pass band positions.

| | | | | Positions of | | Positions of | |
|---|---|---|---|---|---|---|---|
| Data | Reference | | Clock | 1st resonator | | 2nd resonator | |
| Signal | frequency | | frequency | passbands | | passbands | |
| S_{IN,A} | ν_{REF,A} − 200 | GHz | 10 GHz | ν_{REF,A} − 200 | GHz | ν_{REF,A} − 190 | GHz |
| S_{IN,B} | ν_{REF,A} | | 40 GHz | ν_{REF,A} | | ν_{REF,A} − 40 | GHz |
| S_{IN,C} | ν_{REF,A} + 200 | GHz | 10 GHz | ν_{REF,A} + 200 | GHz | ν_{REF,A} + 210 | GHz |
| S_{IN,D} | ν_{REF,A} + 1000 | GHz | 160 GHz | ν_{REF,A} + 1000 | GHz | ν_{REF,A} + 1160 | GHz |

The separation range Δλ_{SR,1} of the first optical resonator OR1 may be selected to be equal to an integer multiple of the separation range of the second optical resonator OR2.

The separation between adjacent reference frequencies V_{REF,A}, ν_{REF,B} may be selected to be substantially equal to the separation range Δλ_{SR,1} of the first optical resonator OR1 multiplied by an integer number.

The separation between adjacent reference frequencies ν_{REF,A}, ν_{REF,B} may be selected to be substantially equal to the separation range Δλ_{SR,2} of the second resonator OR2 multiplied by an integer number.

The separation between adjacent reference frequencies ν_{REF,A}, ν_{REF,B} does not need to correspond an integer multiple of a clock frequency. Thus, the methods and the devices according to the present invention allow considerable freedom to select the spectral positions of the modulated data signals and/or the clock frequencies.

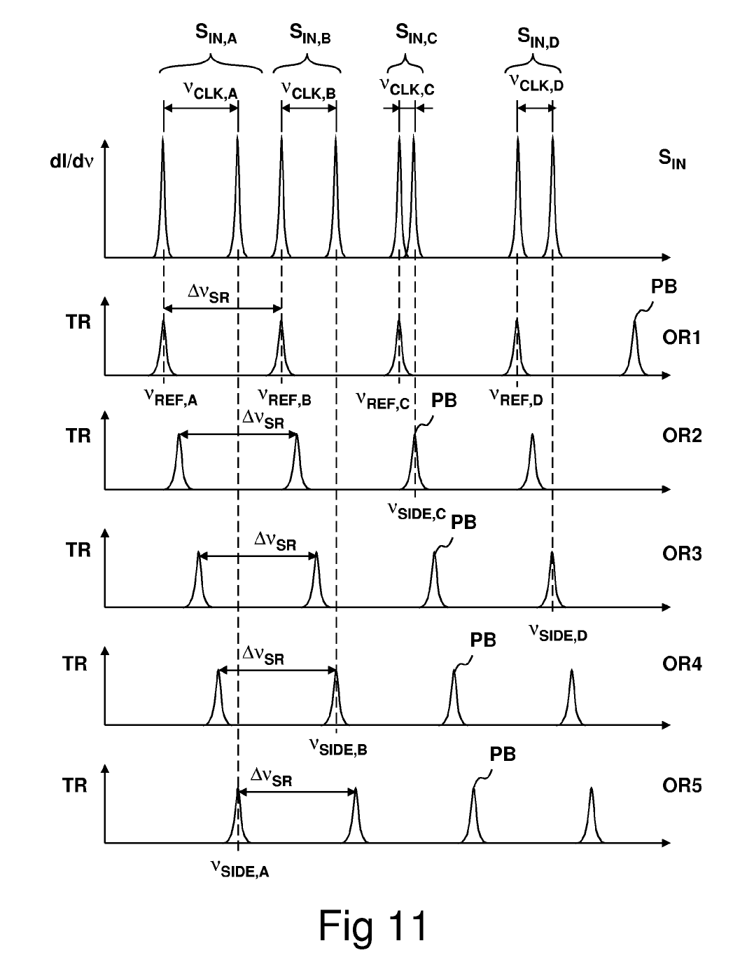

FIG. 10 shows an embodiment of the clock recovery device 100 comprising five substantially identical ring resonators OR1, OR2, OR3, OR4, OR5 optically coupled in parallel. The ring resonators OR1, OR2, OR3, OR4, OR5 have the same separation range Δν_{SR}. FIG. 11 shows how the clock frequencies of four spectrally adjacent data signals S_{IN,A}, S_{IN,B}, S_{IN,C}, S_{IN,D} may be recovered by using the clock recovery device 100 of FIG. 10. The data signals have the same separation between their reference frequencies ν_{REF,A}, ν_{REF,B}, ν_{REF,C}, ν_{REF,D} but different clock frequencies ν_{CLK,A}, ν_{CLK,B}, ν_{CLK,C}, ν_{CLK,D}. The passbands PB of the first ring resonator OR1 are matched with the reference frequencies ν_{REF,A}, ν_{REF,B}, ν_{REF,C}, ν_{REF,D}. The spectral positions of the passbands PB of the other resonators OR2, OR3, OR4, OR5 are selected such that each sideband peak ν_{SIDE,A}, ν_{SIDE,B}, ν_{SIDE,C}, ν_{SIDE,D} matches with one of the passbands of the resonators OR2, OR3, OR4, OR5. For example, a passband of the second resonator OR2 may be matched with the sideband peak ν_{SIDE,C} of the data signal S_{IN,C}, the third resonator OR3 may be matched with the sideband peak of the data signal S_{IN,D}, the fourth resonator OR4 may be matched with the sideband peak of the data signal S_{IN,B}, and the fifth resonator OR5 may be matched with the sideband peak of the data signal S_{IN,A}.

An example of a possible combination of reference frequencies and clock frequencies is presented in Table 2.

TABLE 2
An example of a possible combination of reference
frequencies, clock frequencies and passband positions. OR1, OR2,
OR3, OR4, OR5 refer to the ring resonators of FIGS. 10 and 11.

| Data | Reference | | Clock | | Sideband | | Matched |
|---|---|---|---|---|---|---|---|
| Signal | frequency | | frequency | | frequency | | resonators |
| S_{IN,A} | ν_{REF,A} | | 101 | GHz | ν_{REF,A} + 101 | GHz | OR1, OR5 |
| S_{IN,B} | ν_{REF,A} + 300 | GHz | 39 | GHz | ν_{REF,A} + 339 | GHz | OR1, OR4 |
| S_{IN,C} | ν_{REF,A} + 600 | GHz | 20 | GHz | ν_{REF,A} + 620 | GHz | OR1, OR2 |
| S_{IN,D} | ν_{REF,A} + 900 | GHz | 10.7 | GHz | ν_{REF,A} + 910.7 | GHz | OR1, OR3 |

In the situation according to Table 2, the spectral separation between adjacent reference frequencies is 300 GHz. The separation range Δν_{SR} of the optical resonators OR1 to OR5 is equal to 300 GHz or equal to the spectral separation between adjacent reference frequencies divided by an integer number. The clock frequencies ν_{CLK,A}, ν_{CLK,B}, ν_{CLK,C}, ν_{CLK,D} may be selected independent of the spectral separation between the adjacent reference frequencies ν_{REF,A}, ν_{REF,B}, ν_{REF,C}, ν_{REF,D}. A special advantage is that the clock frequency of any of the data signals S_{IN,A}, S_{IN,B}, S_{IN,C}, S_{IN,D} may also be changed during transmission, providing that at least one of the passbands PB matches with the sideband peak corresponding to the changed clock frequency. The clock frequency of the first data signal S_{IN,A} may changed to be any of the listed clock frequencies 10.7 GHz, 20 GHz, 39 GHz or 101 GHz.

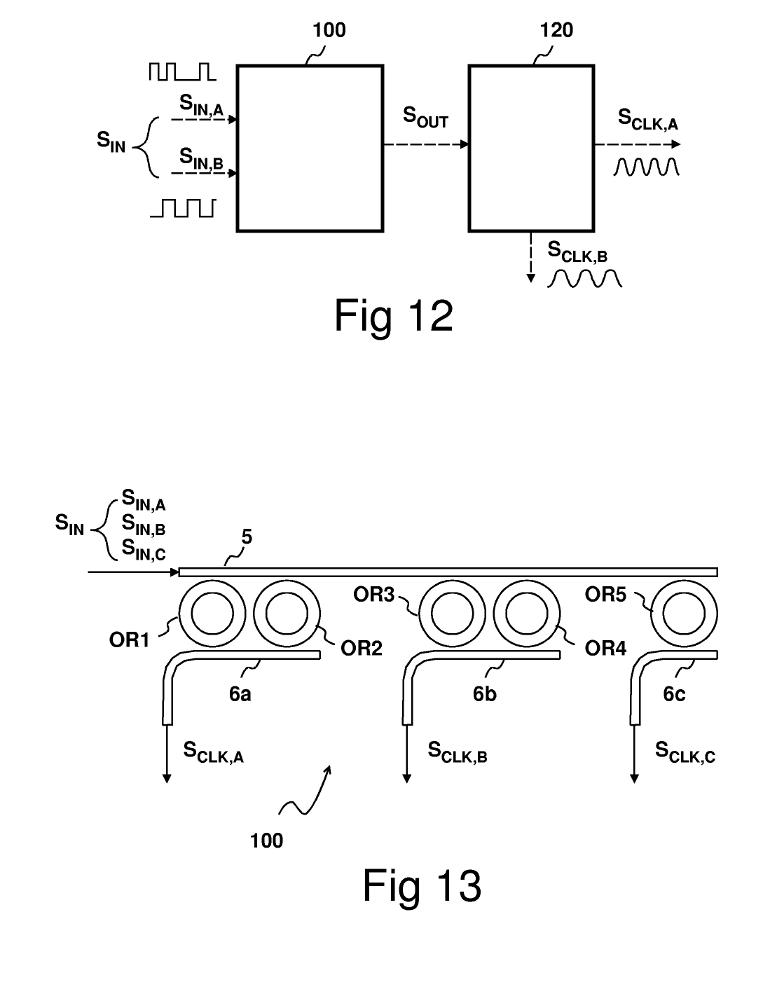

Referring to FIG. 12, the output signal S_{OUT} may comprise recovered clock signals S_{CLK,A}, S_{CLK,B} which are spectrally separate but spatially overlapping. If required, the optical clock signals S_{CLK,A}, S_{CLK,B} may be spatially separated from each other by using a spectral demultiplexer 120. The spectral demultiplexer may be based on e.g. a diffraction grating, an arrayed waveguide, or an interference filter.

Referring to FIG. 13, the clock recovery device 100 may comprise several groups of ring resonators, which groups have separate output waveguides 6a, 6b, 6c. For example, a first group may consist of a first ring resonator OR1 and a second ring resonator OR2 coupled optically in parallel and providing an output to the waveguide 6a. A second group may consist of a third ring resonator OR3 and a fourth ring resonator OR4 coupled optically in parallel and providing an output to the waveguide 6b. A third group may consist of a single ring resonator OR5 adapted to provide output to the waveguide 6c.

The spatial separation of the recovered clock signals S_{CLK,A}, S_{CLK,B}, S_{CLK,C} may be performed at least partly by said groups. For example, the input signal S_{IN} may comprise data signals transmitted on twelve spectrally adjacent data channels S_{IN,A}, S_{IN,B}, S_{IN,C} etc. The first group of ring resonators may be adapted to recover the clock frequencies associated with every third data signal, beginning from the data signal which has the lowest frequency. The second group of ring resonators may be adapted to recover the clock frequencies associated with every third data signal, beginning from the data signal which has the second lowest frequency. The third group may be adapted to recover the clock frequencies associated with the remaining data signals.

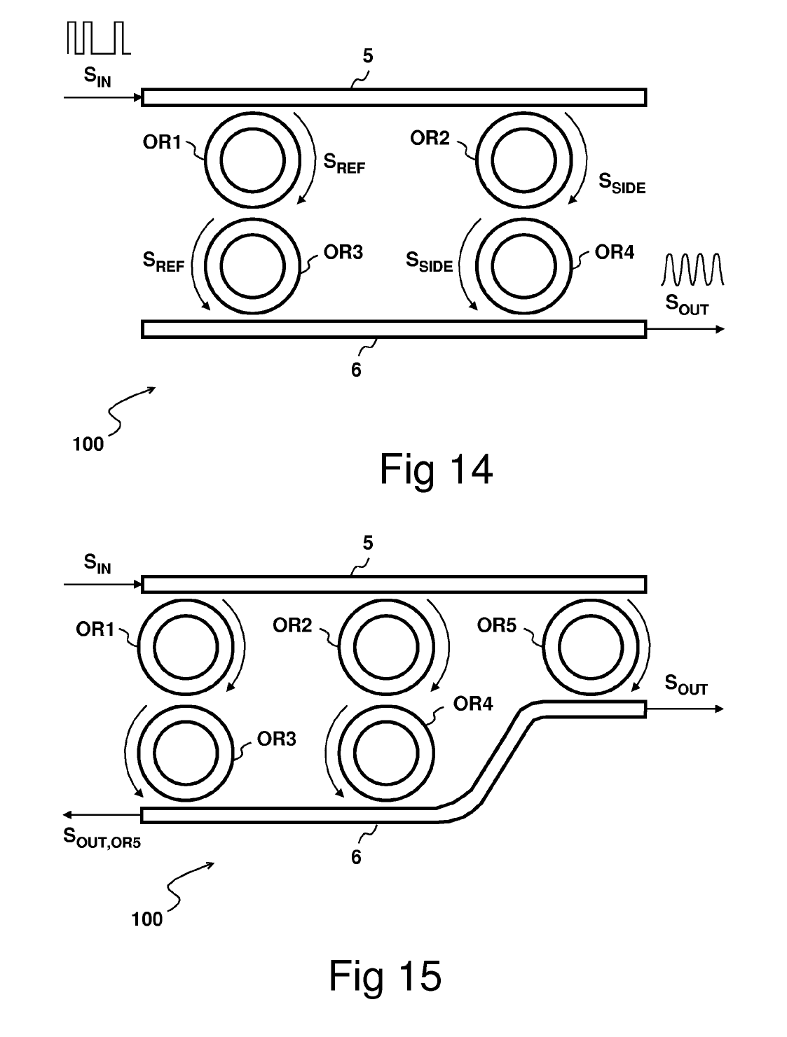

Referring to FIG. 14, the clock recovery device 100 may further comprise ring resonators OR3, OR4 coupled optically in series with the first optical resonator OR1 and with the second optical resonator OR2. The signal component S_{REF} transmitted through the first ring resonator OR1 is coupled to the third ring resonator OR3. The signal component S_{SIDE} transmitted through the second ring resonator OR2 is coupled to the fourth ring resonator OR4.

The coupling of the ring resonators in series may be used e.g. in order to modify the spectral profile of the passbands PB. Especially, the ring resonators may be coupled in series in order to implement a region of a substantially constant phase shift response in the vicinity of a spectral peak, i.e. to implement a phase shift plateau. Thus, a slight mismatch between the spectral peak and the passband of the resonator will not affect the phase of the recovered clock signal.

Also three or more ring resonators may be coupled in series.

Referring to FIG. 15, the clock recovery device 100 may comprise several groups of ring resonators, which groups have ring resonators optically coupled in series. For example, a first group may consist of a first ring resonator OR1 and a third ring resonator OR3 coupled optically in series. A second group may consist of a second ring resonator OR2 and a fourth ring resonator OR4 coupled optically in series. A third group may consist of a single ring resonator OR5. In this example the output S_{OUT,OR5} of the fifth ring resonator OR5 is coupled out of a different end of the second waveguide 6 than the combined output S_{OUT} of the third and the fourth ring resonator OR3, OR4 because the number of resonators coupled in series is even in the first group and in the second group and said number is odd in the third group. The output direction may be reversed e.g. by changing said number from odd to even, or from even to odd.

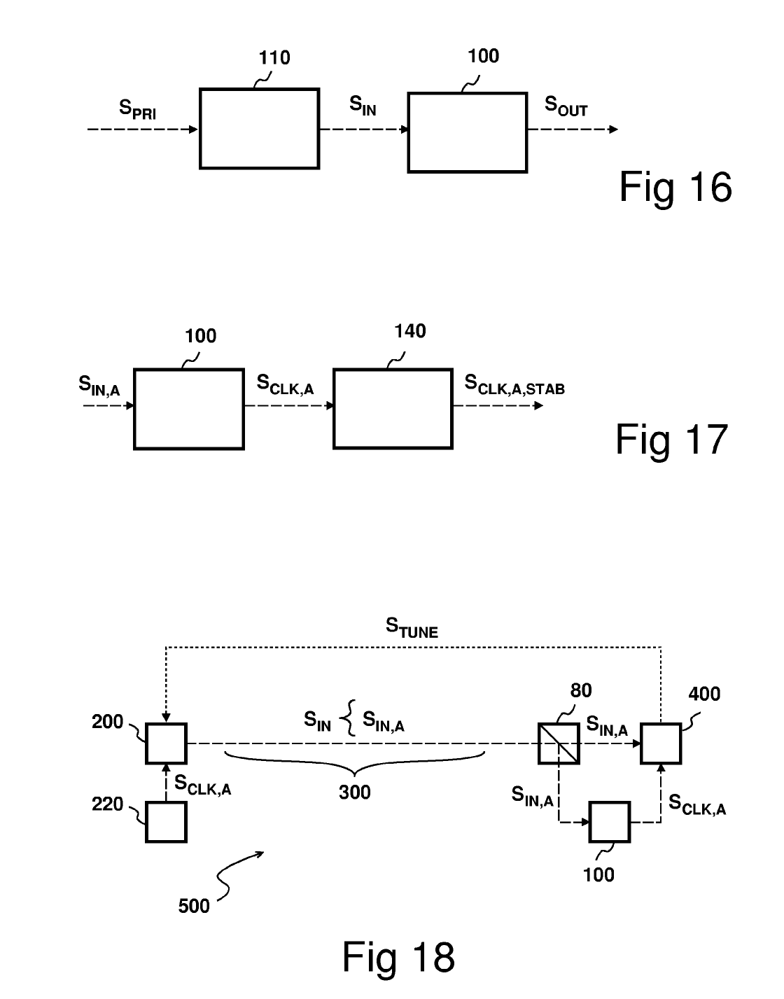

Referring to FIG. 16, an optical primary signal S_{PRI} may be modulated in such a way that it does not comprise sideband components corresponding to the clock frequency ν_{CLK}. For example, the optical primary signal may be modulated according to the non-return-to-zero (NRZ) format. A signal pre-processing unit 110 may be coupled to the clock recovery device 100 in order to generate one or more sideband peaks corresponding to the clock frequency ν_{CLK} of the primary signal S_{PRI}. The pre-processing unit 110 may be implemented e.g. by non-linear devices such as disclosed e.g. in U.S. Pat. No. 5,339,185.

Referring to FIG. 17, an amplitude stabilizing unit 140 may be coupled to the clock recovery device 100 in order to provide a signal S_{CLK,A,STAB} which is stabilized with respect to the amplitude of the beat of the recovered clock signal S_{CLK,A} and/or in order to stabilize the waveform of the beat. The stabilizing unit 140 may be based on an optical resonator exhibiting optical bistability. The stabilizing unit 140 may be based on an optically saturable element. Yet, the stabilizing unit 140 may be based on the use of one or more semiconductor optical amplifiers. A spectral demultiplexer 120 (FIG. 12) may be coupled between the clock recovery device 100 and the amplitude stabilizing unit 140, if required.

Also the amplitudes of the data signals S_{IN,A}, S_{IN,B} may be stabilized before the coupling of the signals to the clock recovery device 100.

The optical resonators OR1, OR2 of the clock recovery device 100 have to be matched with the spectral peaks of the input signal S_{IN}. The matching of the resonators OR1, OR2 may be achieved by tuning the resonators OR1, OR2. The tuning may be based e.g. on maximizing the amplitude of the beat, or on keeping the amplitude of the beat at a predetermined level, which is slightly lower than the maximum amplitude.

The optical resonators OR1, OR2 may also be tuned by using an external frequency reference. Broadband radiation, e.g. white light may be coupled through the resonators, and the spectral position of the passbands PB may be monitored using a spectral analyzer, e.g. a Fourier interferometer. Some lasers and/or amplifiers used in transmitting units 200 may inherently emit also broadband radiation which may be used for tuning purposes.

Thermal expansion of the optical resonators may change the spectral position of the passbands PB. The tuning of the resonators may be performed e.g. by adjusting the temperature of the optical resonators OR1, OR2. The temperature of the optical resonators OR1, OR2 may be adjusted e.g. by using common or separate heating elements. The optical resonators OR1, OR2 may also be placed in an oven having accurately controlled and uniform temperature. The optical resonators OR1, OR2 may be placed in the same oven or in different ovens. The optical resonators may be implemented using materials having a low thermal expansion coefficient, e.g. fused silica or quartz, in order to further increase the accuracy of the tuning.

Referring to FIG. 18, the spectral matching of the resonators OR1, OR2 with the signal peaks may also be achieved by spectrally tuning the transmitting unit 200. A control signal S_{TUNE} is sent from the receiving unit 400 to the transmitting unit 200. The control signal S_{TUNE} may be based e.g. on the magnitude of the beat signal. The transmitting unit 200 may be tuned such that the beat amplitude is maximized or kept at a predetermined level. The control signal S_{TUNE} may be sent optically through the same optical transmission path 300 which is used for transmitting the optical input signal S_{IN}. The control signal S_{TUNE} may be transmitted optically through another transmission path. The control information may also be transmitted electrically or by radio communication.

Thus, the optical system may further comprise:

means to monitor the spectral position of a spectral peak of the input signal S_{IN} with respect to at least one pass band PB of an optical resonator OR1,

means to send a control signal S_{TUNE} to the optical transmitting unit 200, which control signal S_{TUNE} is dependent on said spectral position, and

means to spectrally tune the transmitting unit 200 based on said control signal S_{TUNE} in order to stabilize said spectral position.

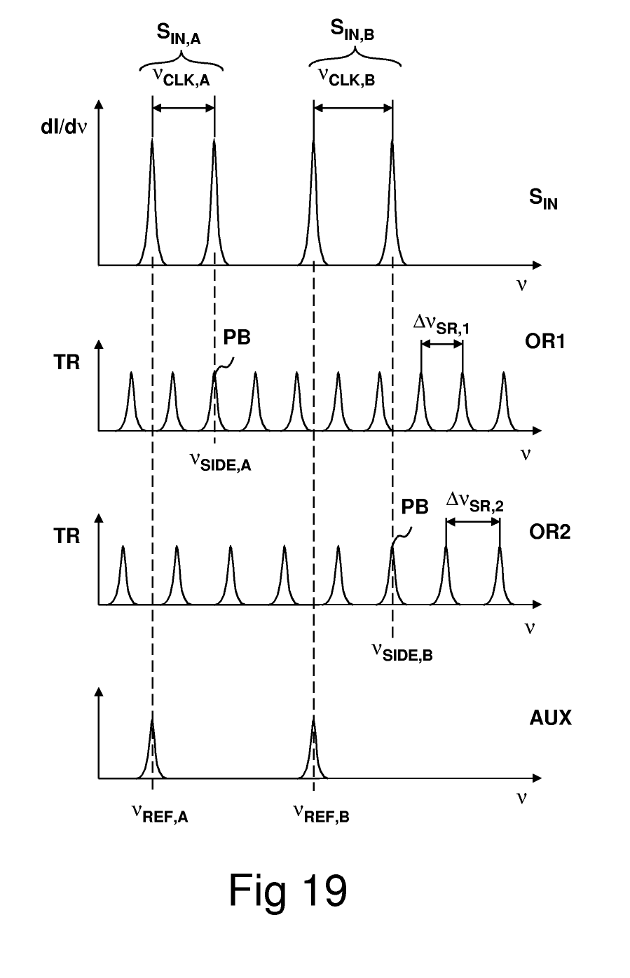

Referring to FIG. 19, auxiliary light AUX may be combined with the outputs of the optical resonators OR1, OR2 in order to further stabilize the beat amplitude of the recovered clock frequencies.

A first spectral peak of the input signal S_{IN} is matched with a passband PB of the first optical resonator OR1, and a second spectral peak of the input signal S_{IN} is matched with a passband PB of the second optical resonator OR2. Spectral peaks of the auxiliary light AUX are matched with a third and a fourth spectral peak of the input signal S_{IN}. The auxiliary light AUX has spectral peaks at frequencies ν_{REF,A}, ν_{REF,B} that correspond to the reference peaks of the data signals. The spectral separation between the peaks of the auxiliary light and the spectral peaks of the data signals is selected to be equal to the clock frequency ν_{CLK,A}, ν_{CLK,B} of each data signal S_{IN,A}, S^{IN,B}.

The auxiliary light AUX is combined with the output of the optical resonators OR1, OR2 in order to recover the clock signals S_{CLK,A}, S_{CLK,B} associated with the data signals S_{IN,A}, S_{IN,B}. The clock signals S_{CLK,A}, S_{CLK,B} exhibit a beat at the clock frequencies ν_{CLK,A}, ν_{CLK,B}.

When compared with the signal S_{REF,A} shown in FIG. 7, the intensity of the auxiliary light AUX does not fluctuate. Thus, the recovered clock signals S_{CLK,A}, S_{CLK,B} exhibit smaller fluctuations than in the case of FIG. 7.

In order to maximize the relative beat amplitude, the intensity of the auxiliary light AUX may be adjusted to be substantially at the same level as the intensity of the output signal S_{OUT} at each sideband frequency.

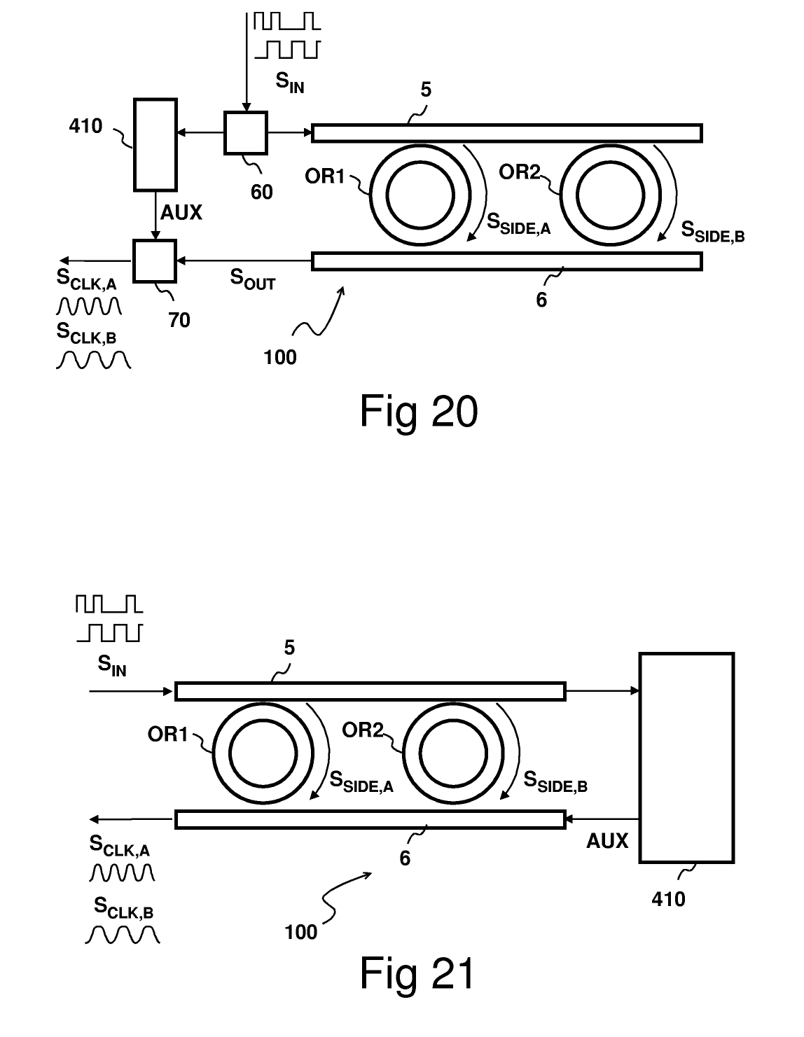

Referring to FIG. 20, the auxiliary light AUX may be provided by one or more auxiliary light sources 410. The auxiliary light AUX is combined with the output S_{OUT} of the clock recovery device 100 by a combiner 70. The auxiliary light source 410 may be a laser which is accurately stabilized. The laser may be stabilized e.g. by locking it spectrally to one or more spectral peaks of the input signal S_{IN}. The input signal SIN may be divided into parts by a splitter 60. Alternatively, the transmitting unit 200 may be spectrally locked to the auxiliary light source 410 (see FIG. 18).

Referring to FIG. 21, the auxiliary light AUX may also be coupled to the end of the second waveguide 6. Furthermore, a part of the input signal S_{IN} may be coupled out of the end of the first waveguide 5 in order to lock the frequency/frequencies of the auxiliary light AUX.

The embodiments according to FIGS. 19 to 21 may also be implemented using only one optical resonator OR1. In that case the spectral separation between matched spectral peaks has to be an integer multiple of the separation range Δν_{SR} of the optical resonator OR1.

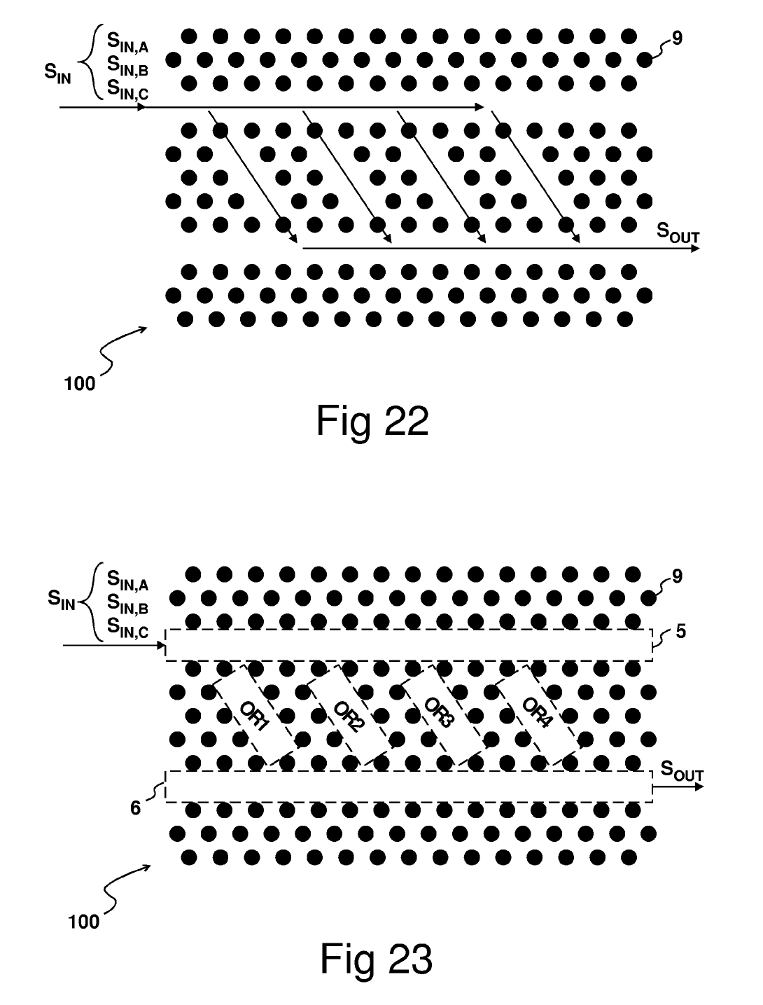

Referring to FIG. 22, the clock recovery device 100 may be implemented using photonic structures. The structure comprises a plurality of substantially periodic features 9, e.g. holes, which manipulate the propagation of light in the structure. FIG. 23 shows the structure of FIG. 22 such that the waveguiding structures and the optically resonating structures are outlined by dashed lines. The input signal S_{IN} is coupled from the first common waveguiding structure 5 to the optically resonating structures OR1, OR2, OR3, OR4. The optically resonating structures OR1, OR2, OR3, OR4 act as Fabry-Perot-type resonators. Light is further coupled out of the optically resonating structures OR1, OR2, OR3, OR4 to the second waveguiding structure 6 in order to form the output signal S_{OUT} The separation ranges of the resonators are selected such that the output signal S_{OUT} comprises at least one recovered clock signal. The optical coupling from the first waveguide 5 to the resonators and from the resonators to the second waveguide 6 may be implemented by evanescent coupling. The resonators may be linear, as shown in FIGS. 22, and 23, or they may have a curved form in two dimensions, e.g. the shape of the letter C. They may have a form in three dimensions, e.g. the shape of a coil.

Referring to FIG. 24, the clock recovery device 100 may be implemented using fiber optic Fabry-Perot resonators. A Fabry-Perot resonator comprises at least two reflectors 7, 8 which define a cavity between them. The polished, cleaved or coated ends of an optical fiber 12 may act as the reflectors 7, 8. The input signal S_{IN} is coupled from the first common waveguide 5 to the fiber optic resonators OR1, OR2, OR3, OR4. Light is further coupled out of the fiber optic resonators OR1, OR2, OR3, OR4 to the second waveguide 6 in order to form the output signal S_{OUT} The separation ranges of the resonators are selected such that the output signal S_{OUT} comprises at least one recovered clock signal.

The signal S_{IN} may be coupled directly from the side of the first waveguide 5 to the optical resonators OR1, OR2, OR3, OR4 by evanescent coupling. The distance d1 between the side of the waveguide 5 and the cavity of an optical resonator may be e.g. in the range of 0.05 to 1 times the wavelength of the coupled signal. The side of the waveguide 5 may be defined e.g. by a boundary which encloses 80% of the optical power transmitted at said wavelength.

FIG. 25 shows a clock recovery device 100 which has two output waveguides 6a and 6b. The input signal S_{IN} is coupled from the common waveguide 5 to the fiber optic resonators OR1, OR2, OR3, OR4. Light is coupled from the fiber optic resonators OR1 and OR2 to the first output waveguide 6a in order to provide a first output signal comprising a first recovered clock signal S_{CLK,A} Light is coupled from the fiber optic resonators OR3 and OR4 to the second output waveguide 6b in order to provide a second output signal comprising a second recovered clock signal S_{CLK,B}, which is spatially separate from the first output signal.

The clock recovery device 100 may be used in combination with optical data receivers, repeaters, transponders or other types of devices used in fiber optic networks. The clock recovery device 100 may also be used in combination with optical data receivers, repeaters, transponders or other types of devices used in optical communication systems operating in free air or in space.

Referring back to FIG. 1, the transmitting unit 200 may be a transmitter of a point-to-point communication system. The receiving unit 400 may be a receiver of a point-to-point communication system 500. The transmitting unit 200 or the receiving unit 400 may be a part of a network node in a communication system 500. The transmitting unit 200 or the receiving unit 400 may be a of a part of a signal repeater, which is adapted to restore the optical signal S_{IN} in long distance communication systems. The transmitting unit 200 or the receiving unit 400 may be a part of a cross-connect, i.e. a circuit switch operating in the electrical domain or in the optical domain. The transmitting unit 200 and/or the receiving unit 400 may be a part of a router adapted to forward data packets in the electrical or optical domain. The transmitting unit 200 or the receiving unit 400 may be a part of a time division add-drop-multiplexer operating in the electrical or optical domain.

The optical transmission path 300 may be an optical fiber, an optical fiber network, a light transmissive material, liquid, gas or vacuum. The transmission path 300 may be used for one-directional or two-directional communication.

The clock recovery device 100 may be implemented by methods of integrated optics on a solid-state substrate using miniaturized components. Indium phosphide (InP) based components or integrated structures may be used. The clock recovery device 100 may also be implemented using fiber optic components. The clock recovery device 100 may also be implemented using separate free-space optical components. The optical resonators OR1, OR2, the spectral separation unit 120 and/or further optical components may be implemented on the same substrate.

The clock recovery device 100 may further comprise light-amplifying means to amplify the optical input signals and/or output signals. The light amplifying means may be implemented by e.g. rare-earth doped materials or waveguides. The light amplifying means may be a semiconductor optical amplifier.

Also optical beam splitters and/or optical circulators may be used in order to distribute the input signal to the resonators and/or to combine signals obtained from the resonators. However, the use of further splitters or combiners adds complexity to the system, and the coupling efficiency may be degraded.

For a person skilled in the art, it will be clear that modifications and variations of the devices and the method according to the present invention are perceivable. The particular embodiments described above with reference to the accompanying tables and drawings are illustrative only and not meant to limit the scope of the invention, which is defined by the appended claims.

1-34. (canceled)

35. A method of recovering at least one clock signal from an optical input signal, said input signal comprising one or more spectrally separate data signals, said method comprising:
coupling said input signal to a first waveguide;
matching a passband of a first optical ring resonator with a first spectral peak of said input signal;
matching a passband of a second optical ring resonator with a second spectral peak of said input signal, the spectral separation between said first and said second spectral peaks being equal to a clock frequency associated with a first data signal;
coupling a first portion of said input signal from said first waveguide to said first optical resonator directly by evanescent coupling;
coupling a second portion of said input signal from said first waveguide to said second optical resonator directly by evanescent coupling;
coupling a first processed signal out of said first optical resonator;
coupling a second processed signal out of said second optical resonator; and
combining said first and said second processed signal in order to form an output signal, said output signal comprising a first recovered clock signal associated with said first data signal.

36. The method according to claim 35, wherein said first and said second processed signals are combined by a second waveguide.

37. The method according to claim 35, wherein said first spectral peak corresponds to a carrier frequency of a data signal, and said second spectral peak corresponds to a sideband frequency of said data signal.

38. The method according to claim 35, wherein said first spectral peak corresponds to a first sideband frequency of the optical input signal, and said second spectral peak corresponds to a second sideband frequency of a carrier-suppressed optical input signal.

39. The method according to claim 35, further comprising:
recovering a second clock signal from the optical input signal.

40. The method according claim 39, wherein said first data signal and said second data signal have different clock frequencies.

41. The method according to claim 39, further comprising:
separating said first clock signal spatially from said second clock signal.

42. The method according to claim 39, further comprising:
matching a pass band of said a first optical resonator with a third spectral peak of said input signal; and
matching a pass band of a third optical ring resonator with a fourth spectral peak of said input signal, the spectral separation between said third and said fourth spectral peaks being equal to a clock frequency associated with a second data signal.

43. The method according to claim 39, further comprising:
matching a pass band of said a first optical resonator with a third spectral peak of said input signal, and
matching a pass band of said second optical resonator with a fourth spectral peak of said input signal, the spectral separation between said third and said fourth spectral peaks being equal to a clock frequency associated with a second data signal.

44. The method according to claim 39, further comprising:
recovering a third clock signal from the optical input signal.

45. The method according to claim 35, wherein the time constant of said optical resonators is greater than or equal to an average time period during which said first data signal does not change its state.

46. The method according to claim 35, further comprising:
stabilizing the beat amplitude of at least one of said recovered clock signals.

47. The method according to claim 35, wherein at least one of said data signals is amplitude-modulated.

48. The method according to claim 35, wherein at least one of said data signals is phase-modulated.

49. The method according to claim 35, further comprising:
spectrally stabilizing at least one of said passbands with respect to said first spectral peak.

50. The method according to claim 35, further comprising:
monitoring the spectral position of said first spectral peak with respect to the spectral position of one of said passbands;
sending control information to an optical transmitting unit on the basis of said spectral position; and
spectrally adjusting said optical transmitting unit based on said control information.

51. The method according to claim 35, further comprising:
generating said second spectral peak based on an optical primary signal.

52. The method according to claim 51, wherein said second spectral peak is generated by a nonlinear optical unit.

53. The method according to claim 51, wherein said primary signal is modulated according to the non-return-to-zero format.

54. A method of recovering at least two clock signals from an optical input signal, said input signal comprising two or more spectrally separate data signals, said method comprising:
coupling said input signal to a first waveguide;
matching a passband of a first optical ring resonator with a first spectral peak of said input signal;
matching a passband of said first optical resonator with a second spectral peak of said input signal;
matching a passband of a second optical ring resonator with a third spectral peak of said input signal;
matching a passband of said second optical resonator with a fourth spectral peak of said input signal, wherein the spectral separation between said first and said second spectral peaks being equal to a clock frequency associated with a first data signal, and the spectral separation between said third and said fourth spectral peaks being equal to a clock frequency associated with a second data signal;
coupling a first portion of said input signal directly from the side of said first waveguide to said first optical resonator by evanescent coupling;
coupling a second portion of said input signal directly from said first waveguide to said second optical resonator directly by evanescent coupling;
coupling a first recovered clock signal out of said first optical resonator; and
coupling a second recovered clock signal out of said second optical resonator.

55. The method of claim 54, further comprising:
matching a passband of a third optical resonator with a fifth spectral peak of said input signal;
matching a passband of said third optical resonator with a sixth spectral peak of said input signal, the spectral separation between said fifth and said sixth spectral peaks being equal to a clock frequency associated with a third data signal; and
coupling a third recovered clock signal out of said third optical resonator.

56. A clock recovery device for recovering at least one clock signal from an optical input signal, said input signal comprising one or more spectrally separate data signals, said device comprising:
a first waveguide;
a first optical ring resonator coupled directly to the side of said first waveguide by evanescent coupling, a passband of said first optical resonator being matched with a first spectral peak of said input signal;
a second optical ring resonator coupled directly to the side of said first waveguide by evanescent coupling, said second optical resonator being coupled optically in parallel with said first optical resonator, a passband of said second optical resonator being matched with a second spectral peak of said input signal such that the spectral separation between said first and said second peaks is equal to a clock frequency associated with a first data signal; and
a second waveguide to combine signals provided by said first optical resonator and said second optical resonator, said second waveguide being adapted to provide an output signal comprising a recovered clock signal associated with the first data signal.

57. The clock recovery device according to claim 56, further comprising:
a stabilizer configured to stabilize the spectral position of a passband of said first optical resonator with respect to said first spectral peak.

58. The clock recovery device according to claim 56, further comprising:
an adjuster configured to adjust the spectral position of a passband of said first optical resonator with respect to said first spectral peak.

59. The clock recovery device according to claim 56, further comprising:
a third optical resonator optically coupled in series with said first optical resonator.

60. The clock recovery device according to claim 59, wherein the combination of said first optical resonator and said third optical resonator is adapted to provide a substantially constant phase shift response in the vicinity of said first spectral peak.

61. The clock recovery device according to claim 56, further comprising:
a stabilizing unit to stabilize the beat amplitude of at least one recovered clock signal.

62. The clock recovery device according to claim 61, wherein said stabilizing unit comprises a component selected from among a semiconductor optical amplifier, an optically saturable element, and an optical resonator exhibiting optical bistability.

63. The clock recovery device according to claim 56, wherein said optical resonators and/or further components comprises integrated optics.

64. The clock recovery device according to claim 63, wherein the integrated optics comprise indium phosphide technology or fused silica technology.

65. An optical system, comprising:
a transmitter configured to send an optical input signal, said input signal comprising one or more spectrally separate data signals;
a transmission path to transmit said input signal;
a receiver configured to receive said input signal; and
a clock recovery device to recover at least one clock signal from said optical input signal, said clock recovery device comprising
a first waveguide,
a first optical ring resonator coupled directly to the side of said first waveguide by evanescent coupling, a passband of said first optical resonator being matched with a first spectral peak of said input signal,
a second optical ring resonator coupled directly to the side of said first waveguide by evanescent coupling, said second optical resonator being coupled optically in parallel with said first optical resonator, a passband of said second optical resonator being matched with a second spectral peak of said input signal such that the spectral separation between said first and said second spectral peak is equal to a clock frequency associated with a first data signal, and
a second waveguide to combine signals provided by said first optical resonator and said second optical resonator, said second waveguide being adapted to provide an output signal comprising a recovered clock signal associated with said first data signal.

66. The optical system according to claim 65, wherein the spectral position of said first spectral peak is stabilized using control information sent to the transmitter.

67. A method of recovering at least two clock signals from an optical input signal, said input signal comprising two or more spectrally separate data signals, said method comprising:
coupling said input signal to a first waveguide;
matching a passband of a first optical ring resonator with a first spectral peak of said input signal;
matching a passband of a second optical ring resonator with a second spectral peak of said input signal;
coupling a first portion of said input signal directly from the side of said first waveguide to said first optical resonator by evanescent coupling;
coupling a second portion of said input signal directly from the side of said first waveguide to said second optical resonator by evanescent coupling;
coupling a first processed signal out of said first optical resonator;
coupling a second processed signal out of said second optical resonator;
combining said first processed signal with auxiliary light in order to form a first recovered clock signal associated with a first data signal; and
combining said second processed signal with auxiliary light in order to form a second recovered clock signal associated with a second data signal, said auxiliary light having a third and a fourth spectral peak such that the spectral separation between said first peak and said third peak is equal to a first clock frequency associated with said first data signal, and such that the spectral separation between said second peak and said fourth peak is equal to a second clock frequency associated with said second data signal.

68. The method according to claim 67, wherein said first processed signal and said auxiliary light are combined using a second waveguide, said first processed signal being coupled to said second waveguide by evanescent coupling, and said auxiliary light being coupled to an end of said second waveguide.

69. The method according to claim 67, wherein said auxiliary light is provided by one or more lasers.
